(19) United States
(12) Patent Application Publication
(10) Pub. No.: US 2019/0230742 A1
(43) Pub. Date: Jul. 25, 2019

(54) Cooking Apparatus with Resistive Coating

(71) Applicant: Regal Ware, Inc., Kewaskum, WI (US)

(72) Inventors: William John Nitz, Muskego, WI (US); Athinodoros Chris Kazanas, Laval (CA)

(21) Appl. No.: 15/880,357

(22) Filed: Jan. 25, 2018

(51) Int. Cl. H05B 1/02; A47J 27/00; A47J 36/02; H05B 3/00

(52) U.S. Cl. CPC H05B 1/0261; A47J 27/004; A47J 36/02; H05B 2203/013; H05B 2203/005; H05B 2203/01; H05B 3/0004

(57) ABSTRACT

A cooking device that includes one or more resistive coatings disposed on a surface of a cooking container. In one embodiment, the resistive coatings are coated to an outside layer of an internal cooking container, which is surrounded peripherally by an external cooking container. The resistive coating converts electricity to heat, thereby heating the internal cooking container. There may be multiple resistive coatings, and a controller is configurable to independently adjust the electric current transiting each of the resistive coatings.

### BACKGROUND OF THE INVENTION

The present invention relates generally to the field of cooking. The present invention relates specifically to a cooking container that uses an internal resistive coating that converts electricity to heat to cook or warm food.

As the field currently stands, typically a cooking container consists of a metal pot with handles that is heated on a surface that supplies heat to the container (e.g., on a natural gas stove-top). Another approach is to use slow cookers that include their own heating elements. The heating element, rather than being a resistive coating, is commonly located inside of an outer container, and heat from the heating element is transferred to an internal container, which contains the food being cooked/heated.

### SUMMARY OF THE INVENTION

One embodiment of the invention relates to a cooking device that includes a cooking container and a stand that the cooking container is placed on. The cooking container is the combination of an internal container and a slightly larger external container, which are affixed together with a cavity between them. The outer surface of the internal container is coated with a resistive coating through which electricity is conducted. The resistive coating efficiently converts electricity into heat, which allows the entire cooking container to heat up very quickly relative to other approaches. The resistive coating is electrically insulated from a body of the internal container by being coated on an insulation coating that is itself directly applied to the internal container.

In one or more embodiments, the resistive coating comprises two resistive paths, a first resistive path that is disposed on a cylindrical sidewall of the internal container, and a second resistive path that is disposed on a bottom of the internal container. A controller in the stand is configured to independently adjust the electric current(s) transiting the first and second resistive paths, although it is contemplated that the controller may in some instances provide the same power at the same time(s) to the resistive paths.

Also disposed on the outside of the internal container are several thermocouples to measure the temperature. In one embodiment a first thermocouple is disposed generally near a center of the bottom of the internal container, a second thermocouple is disposed near an outer edge of the bottom of the internal container, a third thermocouple is disposed near a lower portion of the cylindrical sidewall of the internal container, and a fourth thermocouple is disposed near a middle-to-upper portion of the cylindrical sidewall of the internal container.

The stand includes a display and input device that allows a user to select a target temperature for one or more of the thermocouples. The controller receives the target temperature, sends electricity through the appropriate one or more resistive paths, and measures the temperature at the various locations where the thermocouples are located. When the temperature reaches and/or approaches the target temperature, in one embodiment the controller adjusts the electric current(s) transiting the resistive path(s) such that only a fraction of the electric current(s) is used. Thus, the temperature of the internal container will remain at or near the target temperature. In another embodiment, the controller completely stops the electric current(s) when the target temperature is reached, and re-initiates the electric current(s) when the measured temperature is below the target temperature.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

FIG. 1 is a perspective view of a cooking device, according to an exemplary embodiment.

FIG. 2 is a perspective view of a cooking container, including an internal container and an external container, the external container being partially cut away so that the outer surface of the internal container is partially visible, according to an exemplary embodiment.

FIG. 3 is a perspective view of an internal container, according to an exemplary embodiment.

FIG. 4 is an orthogonal view of a bottom of an internal container, according to an exemplary embodiment.

FIG. 5 is a perspective view of a cooking container, according to an exemplary embodiment.

FIG. 6 is a perspective view from directly above an external container, according to an exemplary embodiment.

FIG. 7 is a cut away profile view of the resistive coating and insulation coating on a portion of an internal container, according to an exemplary embodiment.

FIG. 8 is an exploded perspective view of a couple, which includes a lead, a washer and an attachment piece, according to an exemplary embodiment.

FIG. 9 is a perspective view of a stand, according to an exemplary embodiment.

### DETAILED DESCRIPTION

Referring generally to the figures, various embodiments of a cooking device are shown. Various embodiments of the cooking device discussed herein use an innovative heating system whereby a cooking container is used in conjunction with a stand. The cooking container is made from two separate containers, which are affixed to each other with the external container generally peripherally surrounding the internal container. A resistive coating through which electricity runs is disposed on the outer surface of the internal container, e.g., on the surface of the internal container facing the external container. In one or more embodiments the resistive coating comprises two separate paths, one path on a sidewall (e.g., a cylindrical sidewall) of the internal container and one path on a bottom wall of the internal container. The current transiting each path is separately controllable, thus allowing different locations in the internal container to independently adjustable to different temperatures, although it is contemplated that in some instances the controller may power the resistive paths with the same power at the same times. For example, this embodiment allows the user to specific that the sidewall of the container should be warm but not as hot as the bottom wall. Alternatively, a user can specify that only one of the walls is heated (e.g., the sidewall, the bottom wall) and the other wall is not directly heated.

The body of the internal container is electrically insulated from the resistive coating by virtue of being disposed on an insulation coating, which itself is directly applied to an external surface of the internal container.

The stand includes an interface to connect with the cooking container to provide electricity to the resistive coating(s), and to receive thermal measurements from the cooking container. The stand also includes a display with an interface to accept user commands, such as a target temperature and time to cook.

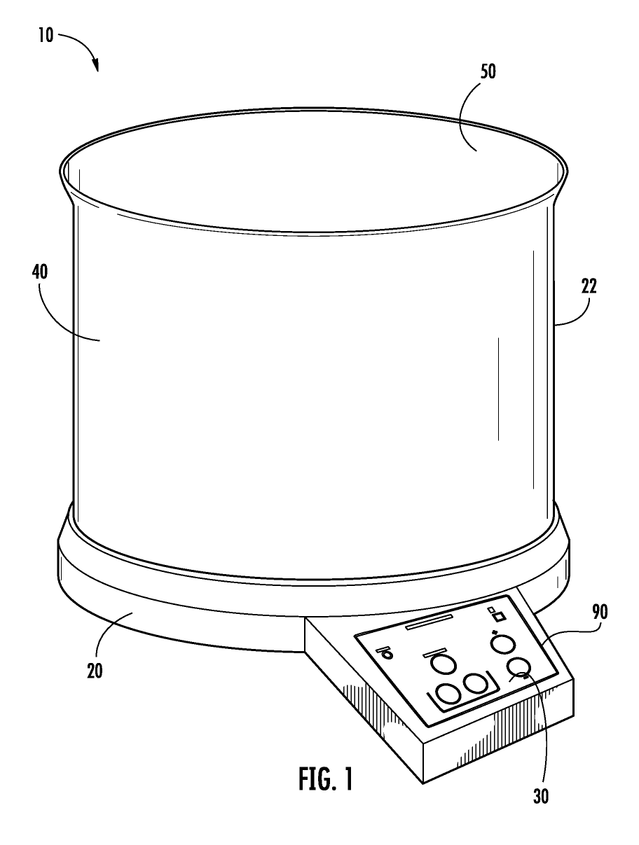

Referring to FIG. 1, in one embodiment a cooking device 10 includes stand 20 and cooking container 22, which is shaped like a pot and configured to cook food. Cooking container 22 is placed on stand 20, and a user inputs commands to controller 30 to select cooking instructions (e.g., turn on/off cooking device, what temperature to make cooking container 20, for how long to remain at that temperature, etc.).

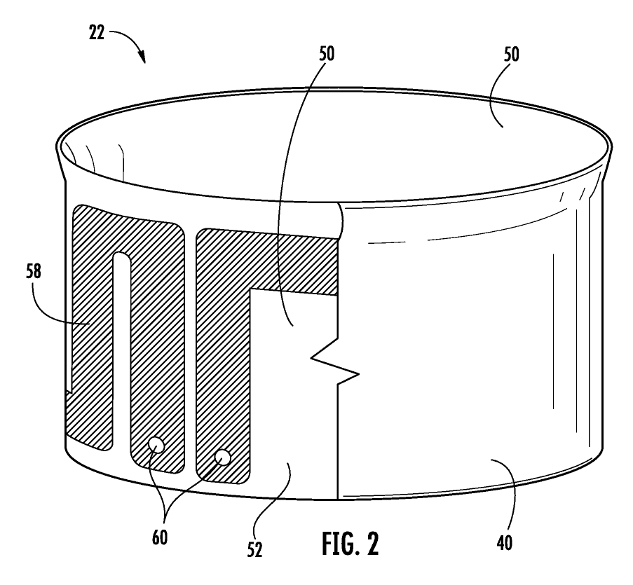

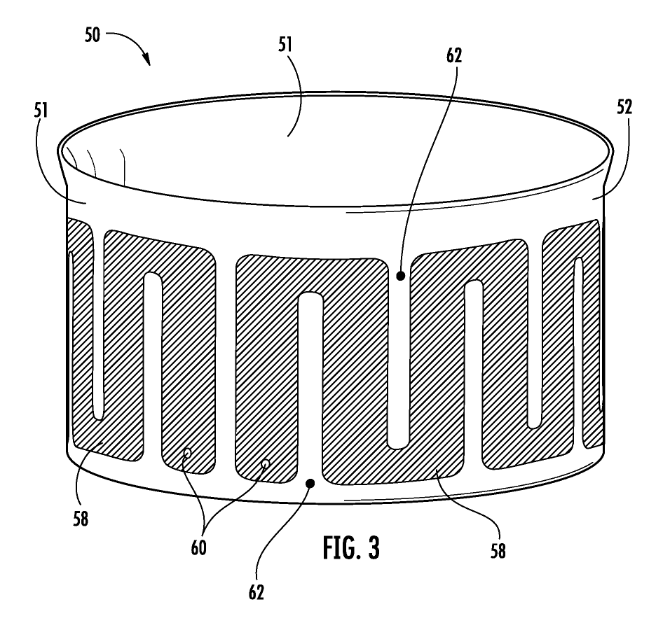

Referring to FIGS. 2-3, cooking container 22 includes inner container 50 and outer container 40. In one or more embodiments, cooking container 22 is a double-walled container and during manufacture an upper edge of outer container 40 is affixed to an upper edge of inner container 50, while the remainder of outer container 40 peripherally surrounds inner container 50.

Inner container 50 includes cylindrical sidewall 52, on which is disposed first resistive path 58. Heating current input connections 60 are located at opposite ends of first resistive path 58, and are connected to wires. During use, electric current transits first resistive path 58 and is converted into heat. Thus, inner container 50, and by extension all of cooking container 22, is heated by electric current transiting first resistive path 58. Specifically, first resistive path 58 heats sidewall 52, and then the heat generated is conducted throughout inner container 50 and to food within inner container 50.

In one or more embodiments, outer container 40 is physically separated from inner container 50 by air, thus electrically insulating outer container 40 from first resistive coating path 58. A heat-resistant electric insulator may be applied to the interior surface of outer container 40, which would provide additional electric insulation between resistive paths 58 and outer container 40.

It is further considered that this separation between outer container 40 and inner container 50 may be maintained by protrusions from inner container 40 that maintain the separation (e.g., screw 88 in FIG. 8). Such protrusions electrically insulate outer container 40 from both first resistive coating path 58 and heating current input connections 60. Thus, protrusions would not themselves provide an electrical connection between first resistive coating path 58 and outer container 40. In specific embodiments, the protrusions are formed from an electrically insulating material such as an insulating polymer material or an insulating ceramic material.

Inner container 50 also includes one or more temperature sensing devices, shown as thermocouples 62, to measure the temperature at various points around inner container 50. Thermocouples 62 are electrically coupled to a communication link, shown as wires 64, over which temperature measurements are communicated to controller 30 in stand 20.

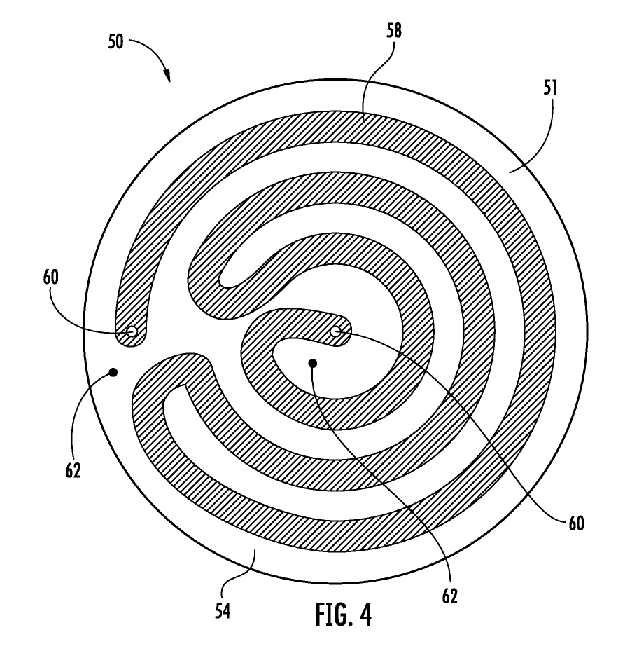

Referring to FIG. 4, bottom 54 of inner container 50 has a second resistive path 58 disposed on a lower surface of bottom 54. Similar to first resistive path 58 on cylindrical sidewall 52, second resistive path 58 also includes two heating current input connections 60 that are located at generally opposite ends of second resistive path 58. In use, wires 64 with electric current are coupled to heating current input connections 60. Electric current transits second resistive path 58, which converts the electricity to heat. Bottom surface 54 of inner container 50 also includes thermocouples 62. Thermocouples 62 measure the temperature of inner container and communicate that information via wires 64 that are coupled to thermocouples 62.

In one or more embodiments, such as are illustrated in FIGS. 2-4, there are two distinct resistive paths. By “distinct” it is meant that the resistive paths do not share or simultaneously use the same portion of resistive coating 58. However, it is contemplated herein that the resistive paths may use the same portion of resistive coating 58, such as for example by sharing at least one heating current input connections 60 (e.g., the connection providing the current and/or the grounding connection).

Further, in the embodiments illustrated in FIGS. 2-4, the distinct resistive paths are each located on a different wall of inner container 50, i.e., first resistive path 58 is on cylindrical sidewall 52 and second resistive path 58 is on bottom 54. However, it is contemplated herein that a given wall of inner container 50 (e.g., cylindrical sidewall 52) may include multiple resistive paths for which the respective electrical current is independently controllable. For example, cylindrical sidewall 52 may have one resistive path located at the lower portion of cylindrical sidewall 52 near bottom 54, and another resistive path located just above the first resistive path. Similarly, bottom 54 may have a first resistive path located generally near the center of bottom 54, and another resistive path located further away from the center of bottom 54.

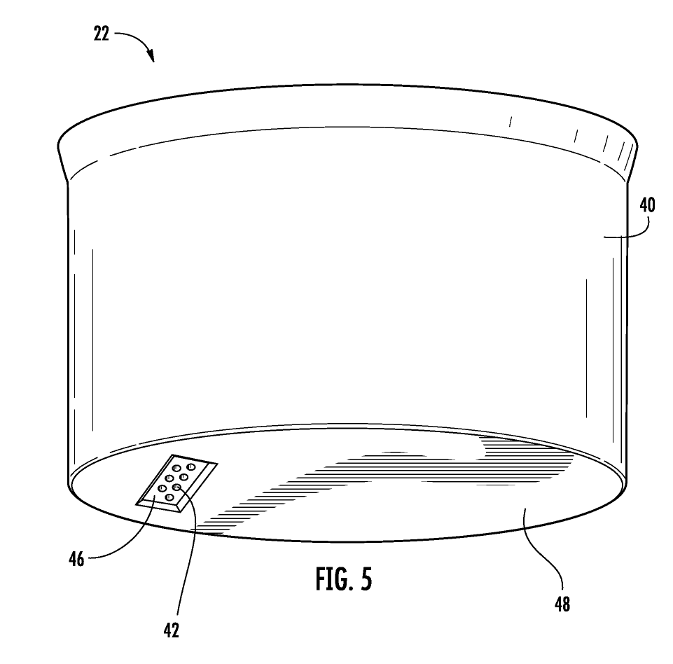

Referring to FIG. 5, bottom 48 of outer container 40 includes an indentation 46 with several external connection points 42. External connection points 42 are configured to permit an electrical connection between stand 20 and inner container 50 via outer container 40. These electrical connections are used to communicate heating electric current for resistive paths 58 and to receive signals indicative of temperature measurements from thermocouples 62. In one or more embodiments external connection points 42 are fluidly sealed such that cooking container 22 is dishwasher-safe.

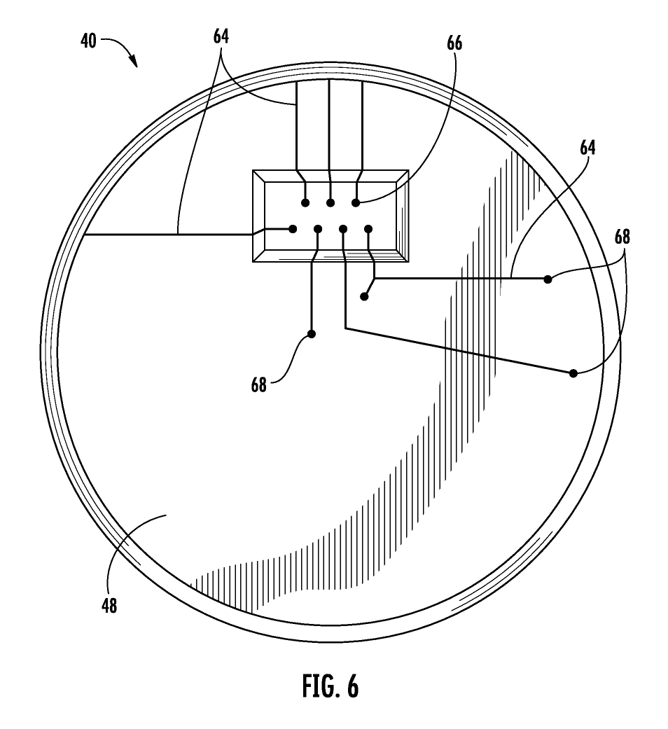

Referring to FIG. 6, the interior of outer container 40 corresponds to indentation 46, and internal connection points 66 correspond to external connection points 42. For example, in the embodiments in FIGS. 5 and 6, there are seven external connection points 42 in FIG. 5 and seven internal connection points 66 in FIG. 6. The internal connection points 66 are electrically coupled to wires 64, and via wires 64 to inter-container connection points 68. Inter-container connection points 68, which are disposed on outer container 40, are coupled to connection points 60 on inner container 50 (shown in FIGS. 2-4). During use, electric current, both for heating resistive paths 58 and measuring temperatures, is transferred over connection points 66 and 68.

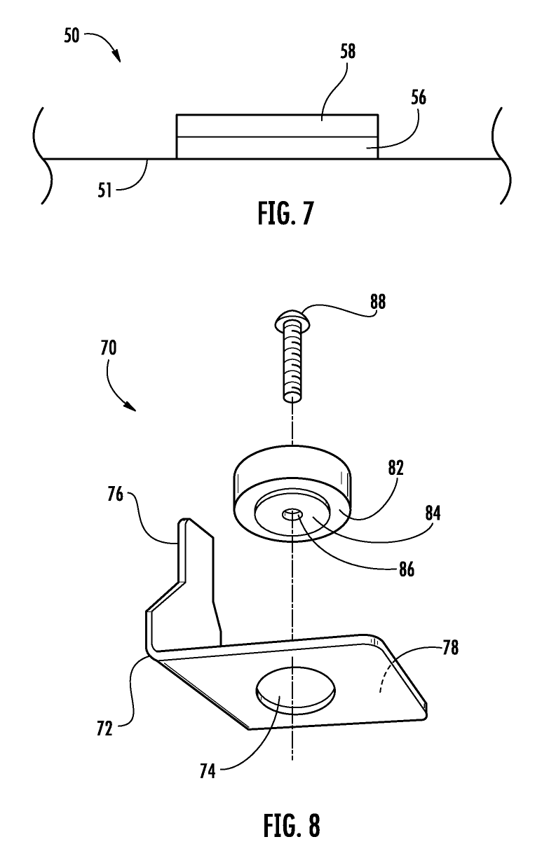

Referring to FIG. 7, resistive coating 58 is electrically insulated from body 51 (e.g., sidewall 52 or bottom wall 54) of inner container 50. In one or more embodiments, resistive coating 58 is deposited on insulation coating 56, which itself is deposited on inner container 50, and insulation coating 56 prevents electric current in resistive coating 58 from transferring to body 51. It is contemplated herein that resistive coating 58 and insulation coating 56 are deposited via any means as would be recognized by those skilled in the art, such as, for exemplary purposes only, spraying, brushing and/or masked evaporative deposition.

In one embodiment, insulation coating 56, which may be referred to as the dielectric, comprises a compound that includes aluminum oxide. Insulation coating 56 is applied to the entire outer surface area of inner container 50, such as via thermal spraying, and the resistive coating 58 is applied in one or more paths.

The deposition of resistive coating 58 may be adjusted in any of several ways. For example, any of several adjustments to resistive coating 58 may be implemented to provide customizable heating parameters, such as the material composition of resistive coating 58, the width of resistive coating 58, and the thickness of resistive coating 58.

As noted above, resistive coating 58 is electrically insulated from body 51 of inner container 50. Further, outer container 40 peripherally surrounds inner container 50. Thus, electricity that transits resistive coating paths 58 will not transfer to either body 51 of inner container 50 or the body of outer container 40. Therefore, both inner container 50 and outer container 40 may be safely handled by a user without risk of electric shock or electrocution, although it should be noted that both inner container 50 and outer container 40 may of course be hot during use.

Referring to FIG. 8, wire 64 is coupled to heating input current connections 60 via attachment piece 88 (e.g., a bolt) and couple 70. Bolt 88 is secured to inner container 50 at heating current input connections 60. Therefore, if bolt 88 becomes electrified, then inner container 50 also becomes electrified.

Accordingly, the purpose of couple 70 is to prevent bolt 88 from becoming electrified. In addition to couple 70 including bolt 88, couple 70 also includes washer 80 and lead 72. Washer 80 is cylindrically-shaped and includes a recessed bottom face 82 and a protruding bottom face 84. Protruding bottom face 84 extends beyond recessed bottom face 82. When washer 80 is placed against lead 72, protruding bottom face 84 is disposed within aperture 74 of lead 72, and recessed bottom face 82 is disposed against and/or adjacent to top face 78 of lead 72. Wire 64 (not shown) is coupled to securing end 76 of lead 72. Finally, attachment piece 88 is placed through central opening 86 of washer 80 and aperture 74 of lead 72.

There are several principal aspects of the configuration of washer 80 that prevent bolt 88 from becoming electrified. First, washer 80 is disposed between the head of bolt 88 and lead 72. Thus, contact between head of bolt 88 and lead 72 is prevented. Second, the bottom surfaces 82 and 84 of washer 80 prevent contact between lead 72 and the axial body of bolt 88 (i.e., the portion of bolt 88 other than the head). When bolt 88 is secured to inner container 50, protruding face 84 is disposed within circular aperture 74 of lead 72. Protruding face 84 therefore prevents lead 72 from laterally moving to contact bolt 88. In one or more embodiments the diameter of protruding face 84 is slightly less than the diameter of circular aperture 74 of lead 72. Therefore, lead 72 is prevented from more moving more than a minimal amount. Accordingly, because washer 80 is not electrically conductive (e.g., because washer 80 is ceramic), bolt 88 is therefore electrically insulated from lead 72, and therefore bolt 88 is prevented from becoming electrified.

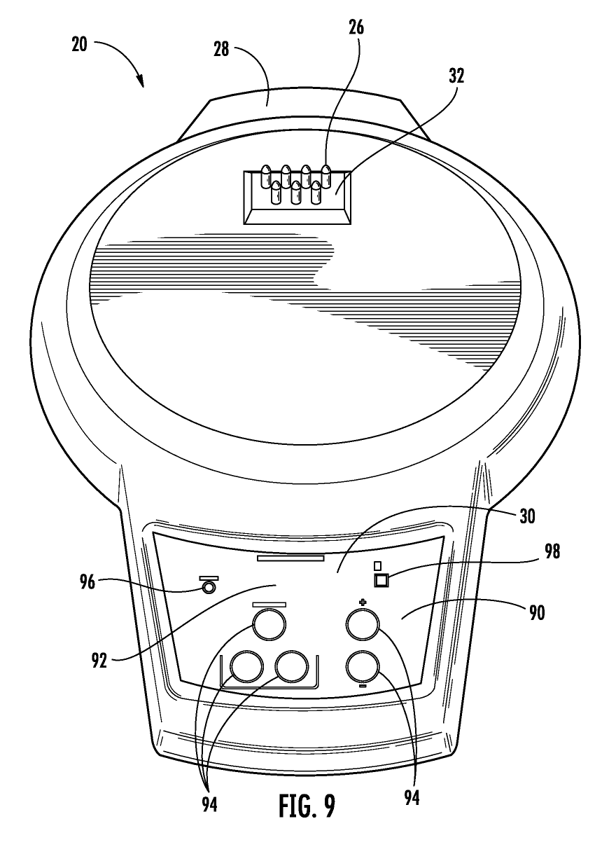

Referring to FIG. 9, cooking container 22 is placed on stand 20 such that indentation 46 of outer container 40 (see FIG. 5) is aligned with connection platform 32. Connection protrusions 26 are disposed through external connection points 42 of outer container 40, thus connecting to internal connection points 66. Connection protrusions 26 both send electrical current to resistive coating(s) 58 and receive thermal measurements from thermocouples 62.

Display surface 90 of stand 20 is one mechanism by which users can operate cooking device 10. In one embodiment, power indicator 96 comprises a light that is illuminated when controller 30 is operating. Heat indicator 98 comprises a light that is illuminated when cooking container 22 is actively controlling the temperature of the cooking surface (e.g., the interior food contact surface of the pan). Input buttons 94 allow users to enter cooking/heating instructions.

In one exemplary situation, a user may instruct controller 30 to heat cooking container 22 to a first temperature D1 for a first amount of time T1, and to a second temperature D2 for a second amount of time T2. The instructions to heat cooking container 22 may be presented as instructions to uniformly heat all of cooking container 22 to the specified temperature, or they may be instructions to heat only a portion of cooking container 22 (e.g., only the bottom surface but not the cylindrical sidewalls) to the specified temperature. A series of cooking/heating instructions may be entered by a user into surface 90, such that a user specifies multiple temperatures and cooking times, and identifies which portion of cooking container 22 are being heated. It is further contemplated herein that controller 30 may receive cooking instructions from other sources, such as, for example, interacting with a cell phone, such as via Wi-Fi or Bluetooth®, interacting with other computer devices through which a user can provide cooking instructions, and receiving instructions from a remote computer (e.g., a server on the internet, which has many different recipes and cooking instructions).

Although the word “container” is used in this specification, and the embodiments in the figures include containers with generally cylindrical sidewalls and flat bottom walls, it is contemplated herein that the inner and outer components of cooking container 22 may be any structures, shapes or configurations (such as both being hemisphere-shaped, both being elliptically-shaped, the inner and outer “containers” being different shapes, etc.) as would be recognized to work with the disclosure described herein.

In another alternative embodiment, inner container 50 is not peripherally surrounded by outer container 40. Thus, to prevent accidental electrical discharge from resistive coating 58, insulation coating 56 is deposited over resistive coating 58 in addition to being deposited under resistive coating 58. Insulation coating 56 is also deposited over all electrified components, such as heating current input connections 60, to prevent electrical current from being discharged other than through the designated resistive path(s) 58.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the invention relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

What is claimed is:

1. A cooking device comprising:
an internal component comprising:
a body defining an outer surface and an inner surface, wherein the inner surface defines a cavity configured to receive food while cooking;
a first resistive coating element disposed on the outer surface, the first resistive coating configured to receive electricity and convert the electricity into heat, wherein the first resistive coating defines a first resistive path that a first electric current transits; and
a second resistive coating element disposed on the outer surface, the second resistive coating configured to receive electricity and convert the electricity into heat, wherein the second resistive coating defines a second resistive path, distinct and separate from the first resistive path, that a second electric current transits; and
an external component coupled to the internal component;
wherein the first and second resistive coatings are electrically insulated from the body of the internal component and are enclosed by the external component.

2. The cooking device of claim 1, wherein the internal component comprises a sidewall and a bottom wall,
wherein the first resistive path is disposed on the sidewall and the second resistive path is disposed on the bottom wall, and
wherein the cooking device further comprises a controller that is configured to control the first electric current independent of the second electric current.

3. The cooking device of claim 1, wherein the cooking device further comprises a controller that is configured to control the first electric current independent of the second electric current.

4. The cooking device of claim 1, wherein the cooking device further comprises a controller that is configured to control the first electric current to be the same as the second electric current.

5. The cooking device of claim 1 further comprising:
a stand configured to support the internal component and the external component, the stand including a plurality of electrical connections,
wherein the external component further comprises a plurality of input connection points that electrically connect with the plurality of connections of the stand when the internal component and external component are supported by the stand.

6. The cooking device of claim 5, wherein the internal component comprises a sidewall and a bottom wall, and wherein the first resistive path is disposed on the sidewall and the second resistive path is disposed on the bottom wall,
wherein the cooking device further comprises a controller that is configured to control the first electric current independent of the second electric current.

7. The cooking device of claim 1 further comprising:
a stand configured to support the internal component and the external component, the stand including a plurality of electrical connection protrusions that are configured to be inserted into a corresponding plurality of connection points in a bottom of the external component.

8. The cooking device of claim 7, wherein the electricity converted to heat by the resistive coating transits at least two of the plurality of connection protrusions, and wherein a body of the external component is electrically insulated from the electricity transiting the at least two of the plurality of connection protrusions.

9. The cooking device of claim 7, wherein the external component further comprises a plurality of input connection points that electrically connect with the plurality of connection protrusions of the stand when the internal component and external component are supported by the stand.

10. The cooking device of claim 7, wherein the internal component further comprises a sidewall and a bottom wall, and wherein the first resistive path is disposed on the sidewall and the second resistive path is disposed on the bottom wall.

11. The cooking device of claim 10, wherein the stand further comprises a controller that is configured to control the first electric current independent of the second electric current.

12. A cooking device comprising:
a cooking container comprising:
an internal container comprising:
a body defining an outer surface and an inner surface, where the inner surface defines a cavity to receive food while cooking;
a first resistive coating element disposed on the outer surface, the first resistive coating configured to receive electricity and convert the electricity to heat, where the first resistive coating defines a first resistive path that a first electric current transits;
a second resistive coating element disposed on the outer surface, the second resistive coating configured to receive electricity and convert the electricity to heat, wherein the second resistive coating defines a second resistive path, distinct and separate from the first resistive path, that a second electric current transits; and
an external component coupled to the internal container around the outer surface of the internal container.
wherein the first and second resistive coatings are electrically insulated from the body of the internal container and are enclosed by the external component.

13. The cooking device of claim 12, wherein the internal container comprises a sidewall and a bottom wall, and wherein the first resistive path is disposed on the sidewall and the second resistive path is disposed on the bottom wall,
wherein the cooking device further comprises a controller that is configured to control the first electric current independent of the second electric current.

14. The cooking device of claim 13, the cooking device further comprising a stand configured to support the internal container and the external component, the stand including a plurality of electrical connections;
wherein the internal container further comprises a plurality of connection points that are configured to electrically connect with the plurality of connections of the stand.

15. The cooking device of claim 12 further comprising:
a stand configured to support the internal container and the external component, the stand including controller and a plurality of electrical connection protrusions that are configured to be inserted into a corresponding plurality of connection points in a bottom of the external component, wherein the controller is configured to control the first electric current independent of the second electric current.

16. A cooking device comprising:
a cooking container comprising:
a body defining an outer surface and an inner surface, wherein the inner surface defines a cavity configured to receive food while cooking;
a first resistive coating element disposed on the outer surface, the first resistive coating configured to receive electricity and convert the electricity to heat, where the first resistive coating defines a first resistive path that a first electric current transits;
a second resistive coating element disposed on the outer surface, the second resistive coating configured to receive electricity and convert the electricity to heat, wherein the second resistive coating defines a second resistive path, distinct and separate from the first resistive path, that a second electric current transits; and
wherein the first and second resistive coatings are electrically insulated from a body of the cooking container.

17. The cooking device of claim 16, wherein the cooking container comprises a sidewall and a bottom wall, wherein the first resistive path is disposed on the sidewall and the second resistive path is disposed on the bottom wall; and
wherein the cooking device further comprises a controller that is configured to control the first electric current independent of the second electric current.

18. The cooking device of claim 16, wherein the cooking device further comprises a controller that is configured to control the first electric current independent of the second electric current.

19. The cooking device of claim 16 further comprising:
a stand configured to support the internal component and the external component, the stand including a plurality of electrical connections, wherein the stand comprises a controller that is configured to control the first electric current independent of the second electric current.

20. The cooking device of claim 19, wherein the cooking container comprises a sidewall and a bottom wall, and wherein the first resistive path is disposed on the sidewall and the second resistive path is disposed on the bottom wall.
